(19) United States
(12) Patent Application Publication
(10) Pub. No.: US 2008/0159324 A1
(43) Pub. Date: Jul. 3, 2008

(54) Method of providing data broadcast/multicast

(76) Inventors: Peter Bosch, New Providence, NJ (US); Johann Galonska, Nuernberg (DE); Sape Mullender, North Plainfield, NJ (US)

Correspondence Address: HARNESS, DICKEY & PIERCE, P.L.C., P.O. BOX 8910, RESTON, VA, 20195, US

(21) Appl. No.: 11/645,603

(22) Filed: Dec. 27, 2006

(51) Int. Cl. H04J 3/26

(52) U.S. Cl. 370/432

(57) ABSTRACT

In one embodiment, a dedicated channel (e.g., is a coded composite transport channel) is configured for each user equipment in a broadcast group based on a first spreading code and a second spreading code. A same first spreading code is assigned to each user equipment in the broadcast group, and the second spreading code is assigned uniquely to each user equipment in the broadcast group. In another embodiment, a transport format combination set is generated for each user equipment in a broadcast group of user equipment. Each transport format combination set indicates valid transport formats for the associated user equipment, and each transport format combination set is configured to support selectively broadcasting and uni-casting over dedicated channels to the broadcast group of user equipment.

### BACKGROUND OF THE INVENTION

Universal Mobile Telecommunications System (UMTS) is one of the third-generation (3G) mobile phone technologies. However, UMTS has a limitation in that it is not possible to broadcast information over dedicated channels, i.e., communication flow from a base station (Node B) and a mobile station (user equipment (EU)).

FIG. 1 is a diagram of a UMTS network to which example embodiments of the present invention may be applied. As shown, a plurality of Node Bs 10 distributed over a given territory (cells) communicate with UEs. The Node Bs 10 are also linked with Radio Network Controllers (RNCs) 20 by a base utilisation interface (lub). The RNCs 20 may be linked with each other by a network utilisation interface (lur). The RNCs 20 and the Node Bs 10 form a UMTS Terrestrial Radio Access Network (UTRAN). UMTS switches 30 are connected to the RNCs 20 by a ulitisation interface (lu), and are also connected to a core network 50. The function and workings of the elements of the UMTS are well known, accordingly the details thereof are omitted.

Handling broadcast data transmission has been a developing concern in wireless communication systems such as UMTS. Generally, broadcast data transmission means audio and/or video broadcasts and/or data services that require simultaneous transmission to a number of UEs in a cell of a Node B. The broadcast data transmission requires a major fraction of the available bandwidth in that cell. Therefore, if such broadcast data were to be transmitted in n individual streams to n UEs, and each of the n individual streams were transmitted over a private dedicated channel, the wireless medium would be inefficiently used as compared to using a single transmission that can be received by the n UEs, simultaneously. Namely, it is currently believed that using dedicated channels to broadcast information is not possible.

Instead, in UMTS, UEs are capable of receiving broadcast information on a Forward Access CHannel (FACH) from a Node-B. The FACH channel is a broadcast channel, but this channel is not power controlled. There is no feedback from the UEs that can be used to reduce the amount of power used by the FACH. Using too much power creates inefficient transmissions because of increased interference with other transmissions from the same Node-B or elsewhere.

### SUMMARY OF THE INVENTION

The present invention relates to a method of providing broadcast and uni-cast of information over dedicated channels.

In one embodiment, a dedicated channel (e.g., is a coded composite transport channel) is configured for each user equipment in a broadcast group based on a first spreading code and a second spreading code. A same first spreading code is assigned to each user equipment in the broadcast group, and the second spreading code is assigned uniquely to each user equipment in the broadcast group.

In accordance with this embodiment, information may be broadcast by sending same broadcast information over the dedicated channel for each user equipment, i.e. over the one shared spreading code and replicated over each individual second spreading for each UE.

Also in accordance with this embodiment, information may be uni-cast to a selected user equipment in the broadcast group by sending uni-cast information over only the dedicated channel of the selected user equipment and sending undecodable information over the dedicated channels of unselected user equipment in the broadcast group, i.e. the one shared spreading code is broadcast to all users, while only a single second spreading code is used for unicast data. Only the intended UE can decode the information.

Alternatively, in accordance with this embodiment, information may be uni-cast to a selected user equipment in the broadcast group by sending uni-cast information over only the dedicated channel of the selected user equipment and sending an invalid transport format indicator over the dedicated channels of the unselected user equipment. The unselected user equipment treats the transport format indicator as invalid since it has not been informed of the coding details associated with the transport format.

In another embodiment, a transport format combination set is generated for each user equipment in a broadcast group of user equipment. Each transport format combination set indicates valid transport formats for the associated user equipment, and each transport format combination set is configured to support selectively broadcasting and uni-casting over dedicated channels to the broadcast group of user equipment.

For example, the generating may include configuring a broadcast portion and uni-cast portion of each transport format combination set. The broadcast portion may be configured such that a same transport format indicator in the broadcast portion of each transport format combination set indicates a same transport format. The uni-cast portion may be configured such that each transport format combination set is associated with one of the user equipment in the broadcast group to provide for uni-casting to the associated user equipment.

According to one alternative, the uni-cast portion of each transport format combination set is configured to include a transport format indicator for each user equipment in the broadcast group. The transport format indicator for a particular user equipment indicates a transport format providing for transmission of data if the transport format indicator is in the transport format combination set associated with the particular user equipment; and the transport format indicator for the particular user equipment indicates a transport format providing for no transmission of data if the transport format indicator is in one of the transport format combination sets not associated with the particular user equipment.

In another alternative, the uni-cast portion of each transport format combination set is configured to include a transport format indicator for each user equipment in the broadcast group. The transport format indicator for a particular user equipment indicates a transport format providing for transmission of data if the transport format indicator is in the transport format combination set associated with the particular user equipment; and the transport format indicator for the particular user equipment exists only in the transport format combination set associated with the particular user equipment.

As will be appreciated, uni-casting information to a selected user equipment is performed using the transport format indicator associated with the user equipment. And, broadcasting information to the broadcast group is performed using one of the transport format indicators in the broadcast portion of the transport format combination sets.

### BRIEF DESCRIPTION OF THE DRAWINGS

Example embodiments of the present invention will become more fully understood from the detailed description given herein below and the accompanying drawings, which are given by way of illustration only and thus are not limiting of the example embodiments of the present invention.

FIG. 1 is a diagram of a UMTS network;

FIG. 2 illustrates a structure of a downlink dedicated physical channel in a mobile communication system;

FIG. 3 illustrates a flow chart of the method of broadcast information over dedicated channels according to a first embodiment of the present invention;

FIG. 4 illustrates an embodiment of configuring transport format combination sets to provide for selective broadcast and uni-cast of information;

FIG. 5 is a flow chart illustrating the selective broadcast/uni-cast process according to an embodiment of the present invention; and

FIG. 6 is a flow chart illustrating example operation at a UE in response to broadcast or uni-cast according to the present invention.

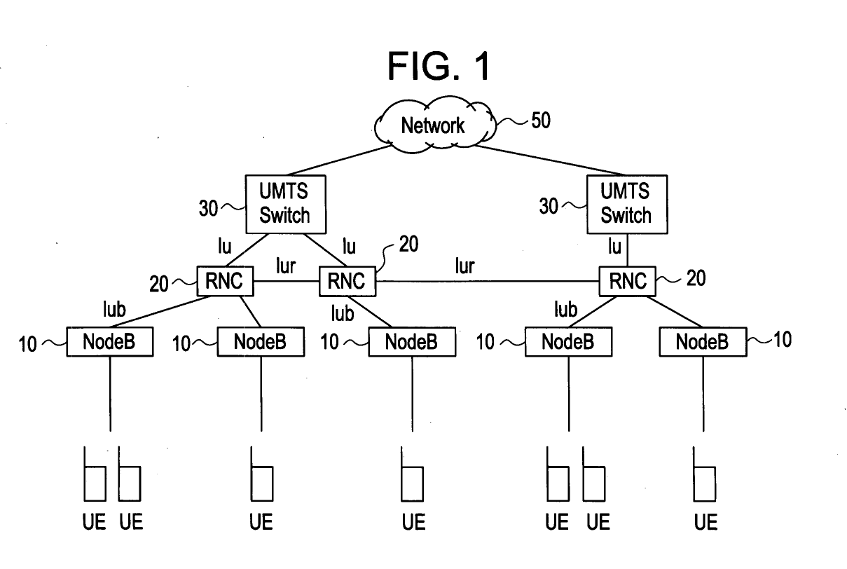

### DETAILED DESCRIPTION OF THE EXAMPLE EMBODIMENTS

Although example embodiments of the present invention will be described with reference to a UMTS, a person of ordinary skill will recognize the present invention may applied to other telecommunication systems.

As discussed above, it is well-known that UEs are capable of receiving broadcast information on a Forward Access CHannel (FACH) from a Node-B. The FACH channel is a broadcast channel, but this channel is not power controlled. There is no feedback from the user equipment (EUs) that can be used to reduce the amount of power used by the FACH. Using too much power creates inefficient transmissions because of increased interference with other transmissions from the same Node-B or elsewhere.

However, dedicated channels are power controlled, and therefore, offer a better prospect for transmitting large amounts of data without creating too much interference. For example, inner-loop power control for a downlink dedicated channel is facilitated by the UEs transmitting power control bits in an uplink dedicated channel.

As is well-known, in UMTS, a dedicated channel is known as a Dedicated Physical CHannel (DPCH) and may include a Dedicated Physical Control Channel (DPCCH) and a Dedicated Physical Data Control CHannel (DPDCH). The DPDCH is a physical channel on which a payload (e.g., IP data, voice, etc.) as well as higher layer signaling (radio resource control (RRC) and Non Access Stratum (NAS) signaling) is transmitted uplink by the UEs to the Node-Bs. The DPCCH is a physical control channel on which signaling is transmitted by UEs to Node-Bs and vice versa. The DPCCH is used to carry control information for the DPDCH. Namely, the DPCCH contains the Transport Format Combination Indicator (TFCI), the power control bits, and other bits to control the data transmission over the DPDCH. The TFCI describes the format of the bits in a radio frame for the set of layer-2 logical bearers mapped onto the DPDCH.

As is further well-known, at layer-2, logical data and control bearers are maintained between the UEs and the Radio Access Network (RAN). For IP service, layer-2 provides a Dedicated Traffic CHannel (DTCH) and three or four Dedicated Control CHannels (DCCHs). The DTCH is a channel dedicated to one UE for transferring user information. The DCCH is used for signaling between the network and the UE. The DTCH and the DCCHs are multiplexed into the same DPDCH and are transmitted together over the DPCH. On reception, a receiver first decodes the TFCI to ascertain how to decode the DPDCH. The mapping from the logical bearers at layer-2 to the DPCH is done via Transport CHannels (TrCHs) and Combined Coded (or “Coded Composite”) Transport CHannels (CCTrCHs).

Addressing is implicit by the dedicated channel and not supplied by addressing information in the control and data messages; therefore, control and data messages can only be delivered to a particular UE by using the UE's dedicated channel. If a dedicated channel is to be used as a broadcast channel, all messages encoded in the DCCH will unavoidably be transmitted to all participating UEs in a broadcast set, even if the DCCH control message was only intended for a specific UE.

In a UMTS, it is well-known that each independent data stream forms a TrCH. A set of TrCHs may form a CCTrCH. In general, current UMTS UEs can only support one physical channel (spread channel) per CCTrCH and can only decode a single CCTrCH at a time. Embodiments of the present invention support broadcasts using DPCH, in part by supplying addressing information in the CCTrCH to indicate the intended destination of the broadcasts and control information. These embodiments will be described in greater detail below.

In general, it is well known that a Dedicated Physical CHannel (DPCH) may be built up from one or more physical radio channels that are orthogonally coded. Also in a UMTS of, for example, wideband code division multiple access (W-CDMA), the actual data stream that is transmitted over air is a bit stream multiplied by a CDMA spread spectrum spreading-code having a particular spreading length. Within the W-CDMA, spreading lengths are generally between 4 and 512. The longer the spreading code, the less bandwidth allocated within that spreading code. A typical Dedicated Control CHannel (DCCH) control bearer mapped onto a Transport Channel (TrCH) and a Combined Coded Transport Channel (CCTrCH) uses a physical radio channel with a spreading code of length 256. Once data service is initiated, e.g., IP communication, additional physical channels with different spreading lengths may be associated with the CCTrCH to enlarge the capacity of the combined physical radio channel. Alternatively, the spreading code of length 256 for the DCCH may be relinquished and replaced by a shorter spreading code channel, e.g., one with more bandwidth.

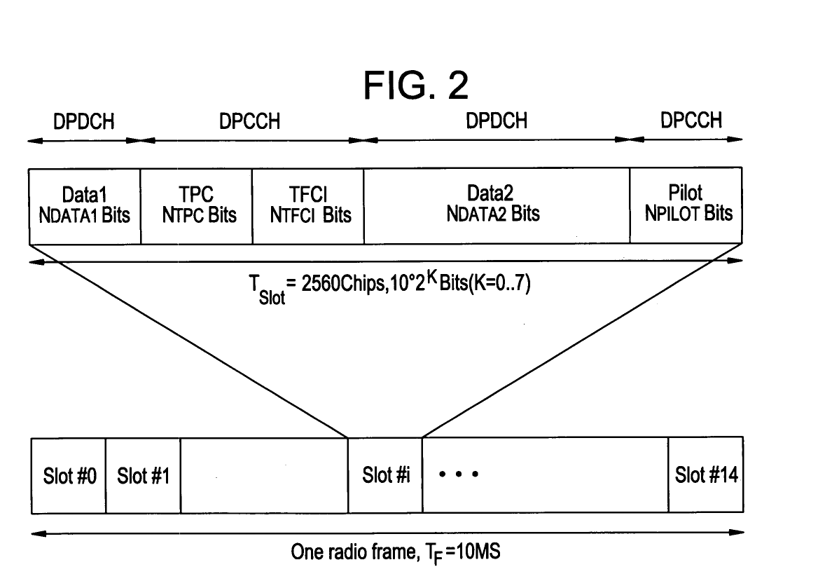

FIG. 2 illustrates a structure of a downlink dedicated physical channel in a mobile communication system. For example, each frame of the downlink DPCH includes 15 slots, Slot#0-Slot#14. Each slot includes DPDCHs for transmitting upper layer data from a Node B to a UE, and DPCCHs for transmitting a physical layer control signal. The DPCCH may also include a Transport Power Control (TPC) symbol to control transmission power of the UE, a TFCI symbol, and a pilot symbol. As further illustrated in FIG. 2, each of the slots Slot# 1-Slot#14 constituting one frame of the downlink DPCH includes 2560 chips. A first data symbol Data1 and a second data symbol Data2 represent upper layer data transmitted from the Node B to the UE over the DPDCH, and the TPC symbol represents information for controlling transmission power of the UE by the Node B. The TFCI symbol indicates a transport format combination (TFC) used for a downlink channel transmitted for a current one frame (=10 ms). Also, the pilot symbol represents a criterion for controlling transmission power of the DPCH by the UE. Information included in the TFCI may be classified into a dynamic portion and a semi-static portion. The dynamic portion includes Transport Block Size (TBS) information and Transport Block Set Size (TBSS) information. The semi-static portion includes Transmission Time Interval (TTI) information, channel coding scheme information, coding rate information, static rate matching information, etc. Therefore, the TFCI indicates the number of transport blocks (TB) in a channel transmitted for one frame, and assigns unique numbers to the TPCs used in each of the transport blocks.

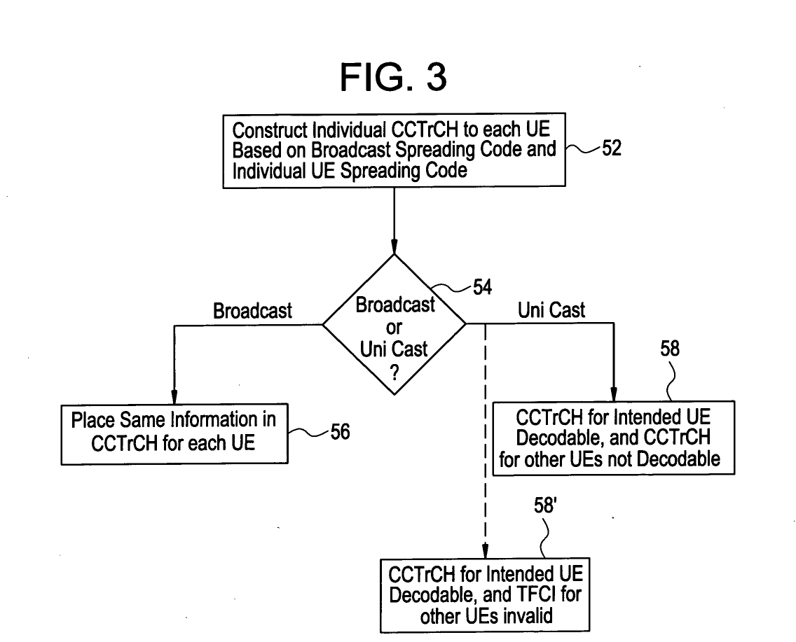

FIG. 3 illustrates a flow chart of the method of broadcast information over dedicated channels according to a first embodiment of the present invention. As shown, in step S2, to achieve broadcast in a cell to a number of user equipments (UEs), and at the same time address an individual UE for control messages over a DCCH, an individual CCTrCH may be provided to each UE by means of a broadcast spreading code and an individual spreading code. All UEs may share the broadcast spreading code, but are individually assigned control spreading codes/physical channels for control purposes. It will be understood, that this requires using multiple physical channels per CCTrCH. In this manner, the CCTrCH for a UE is a dedicated channel of the UE.

The UMTS channel coding standard (Generation Partnership Project (3GPP 25.212)), discloses that data is spread over all channels that are part of the CCTrCH by a second interleaver and a physical channel mapper. Although a spreading code only meant for the control channel may be allocated by way of data distribution, broadcast data ends up on the control spreading code and control data ends up in the broadcast spreading code.

Next, in step S4, the Node B receives information for broadcast to an entire broadcast group of UEs or receives information for uni-cast to a single, intended UE. If broadcast, then in step S6, the individual CCTrCHs for the UEs in the broadcast group are established to carry exactly the same information. Therefore, even though the CCMrCHs are unique or dedicated by way of the per-UE physical channel, after coding, the information that is sent to the UEs is identical. This may be achieved by ensuring that all the per-UE TrCHs hold the same information.

Returning to step S4, if a uni-cast transmission is desired, then in step S8, only the CCTrCH destined for the intended UE will contain valid and decodeable data. For all other UEs of the broadcast set, the transmitted data is configured such that the data is not decodable and leads to a CRC error when an attempt is made to decode the data. This means that the TrCH destined for the specific (intended) UE holds data, while the TrCHs of the other EUs do not hold data. In this manner, only the addressed UE receives the data. Alternatively or additionally, as shown by step S8′, an invalid Transport Format Combination Indicator (TFCI), to prevent decoding the message, may be sent to the other members of the broadcast set.

Since the DPCCH's power control bits are mapped on a first physical channel in a multi-code CCTrCH (3GPP 25.211), the uplink power may be controlled by sending individual power control bits to each UE of the broadcast set independently.

According to one embodiment of the present invention, a narrow physical channel for the per-UE portion of the broadcast channel may be assigned while assigning a wide physical channel for the broadcast portion. This will enable an efficient use of the wireless down-link channel. Alternatively, the broadcast channel may be created from more than one physical channel in parallel, e.g., n physical channels of bandwidth b may have the same bandwidth as a single physical channel of bandwidth n×b.

Another example embodiment of broadcasting using dedicated channels will now be described. This embodiment provides for broadcast even when only a single physical channel and a single CCTrCH are used to broadcast data.

In this embodiment, a transport format associated with a CCTrCH is used to include UE addressing information. To send data to a single UE, a UMTS protocol stack may provide data in the form of transport blocks of a particular size and number. Collectively, DCCH bearers feed into a TrCH and the DTCH feeds into a separate TrCH at Layer-1 (3GPP 25.212). While coding the channel, multiple TrCHs are combined in the CCTrCH, which are then spread over one or more physical channels.

Layer-1 combines multiple TrCHs into a CCTrCH by taking into account the amount of data that is available in each of the TrCHs. Each of the TrCH represents a number of transport blocks of a given size. Based on the Transport Format Combination Set (TFCS) associated with the CCTrCH, Layer-1 then selects a mode of transmission over the CCTrCH. Layer-1 represents the layout of the data on the CCTrCH by way of a Transport Format Combination identifier (TFCI), which is a per-CCTrCH unique identifier describing, for each TrCH embedded in the CCTrCH, the number and the size of transport blocks.

Broadcast services and uni-cast services in a cell may be implemented by assigning Transport Format Combinations to the UEs. In effect, the TFCI space is allocated such that when broadcast information is transmitted over the CCTrCH channel, the UEs in the broadcast group are able to decode the information; while, when control messages are transmitted over the CCTrCH, only a single UE is capable of decoding the message. Namely, the RNC configures a TFCS for each UE in a broadcast group to include a broadcast portion and uni-cast portion.

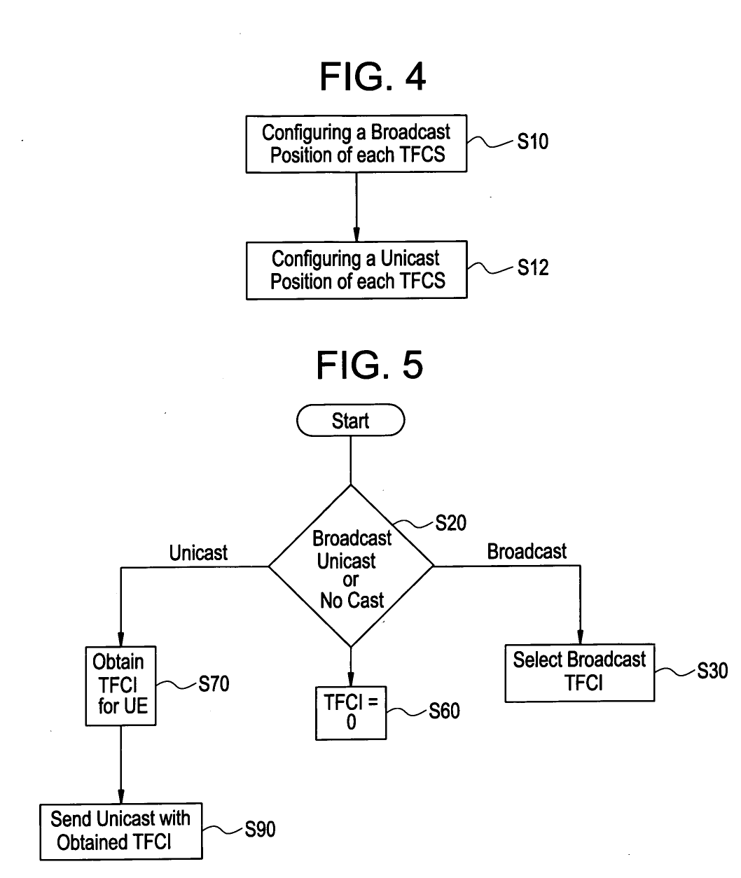

FIG. 4 illustrates an embodiment of configures the TFCSs to provide for selective broadcast and uni-cast of information. As shown, in step S10, the Node B configures a broadcast portion of the TFCS for each UE. The broadcast portion in each TFCS will have the same TFCI and the same TFCI in the different TFCSs will have the same transport format (TF). The TF defines a combination of attributes, which may include error protection, timing, interleaving, bit rate, mapping onto physical layer, etc. At least one of the transport formats (i.e., at least one of the TFCI) will provide for the transport of data. The broadcast portion may also include one TFCI that has a “no data” transport format; namely, this TFCI indicates no data is transmitted.

Table 1 will be used to explain the TFCSs for selectively providing broadcast and uni-cast of data to a broadcast group of three UEs (e.g., UE(A), UE(B) and UE(C)). In the example of Table 1, each column under the heading UE(A), UE(B), UE(C) is a TFCS for that UE. The broadcast portion of each TFCS includes three TFCI, numbered 0, 1 and 2. In this embodiment, three TFs are provided for broadcast, and indicate transmission of zero, one, and two blocks of a particular size X. Namely, the TFCI of “0” indicates the “no data” transmission format.

TABLE 1

| TFCI | UE(A) | UE(B) | UE(C) | Broadcast |
|---|---|---|---|---|
| 0 | 0 | 0 | 0 | 0 |
| 1 | 1 × X | 1 × X | 1 × X | 1 × X |
| 2 | 2 × X | 2 × X | 2 × X | 2 × X |
| 3 | 0 | 0 | 1 × Y | 0 |
| 4 | 0 | 1 × Y | 0 | 0 |
| 5 | 1 × Y | 0 | 0 | 0 |

Returning to FIG. 4, after configuring the broadcast portion, the Node B configures the uni-cast portion of each TFCS. Here, each TFCS is configured such that a TFCI is associated with each UE and has a TF permitting data reception by only the associated UE. According to a first embodiment, the uni-cast portion of the TFCS for each UE includes the same TFCIs, but the TFCIs have different transport formats. In particular, only the transport format of the TFCI in the TFCS associated with the UE indicates data transmission. The same TFCI in the TFCSs of the unassociated UEs have the “no data” transport format. This method of configuring the uni-cast portion is shown in Table 1.

As shown in Table 1, TFCI 3 is associated with UE(C), TFCI 4 is associated with UE(B), and TFCI 5 is associated with UE(A). As such, the transport format of TFCI 3 in the TFCS of UE(C) indicates transmission of one block of a particular size Y. By contrast, the same TFCI 3 in the TFCSs of UE(A) and UE(B) indicate the “no data” transport format.

According to an alternative method, the TFCIs for uni-cast transmission are only assigned to one UE; namely, the TFCI for a UE only appears in the TFCS of that UE. For example, in Table 1, the TFCI of 3 would appear in the TFCS of UE(C) as shown in Table 1, but the TFCI of 3 would not appear in the TFCSs of UE(A) or UE(B). As such this TFCI will be interpreted as invalid by UE(A) and UE(B), and these UEs will not decode the data transmission.

To summarize using Table 1, to send data on the broadcast channel, Layer-1 selects one of TFCIs 0, 1 or 2. The meaning of these TFCIs is the same for all UEs, therefore, they will all decode the broadcast data in the same way. To send data to only UE(A), Layer-1 selects TFCI 5.

In both assignment schemes, UE(A) will recognize and correctly decode the control message. In the first assignment scheme, UE(B) and UE(C) will recognize the TFCI as one that holds no data, so they will not interpret the control packet intended for UE(A). In the second assignment scheme, UE(B) and UE(C) will not recognize the TFCI, because the TFCI was not assigned to them. UE(B) and UE(C) will not be able, or even attempt, to decode the control data intended for UE(A).

FIG. 5 is a flow chart illustrating the selective broadcast/uni-cast process according to an embodiment of the present invention.

It is first assumed that a Node B has already sent and UEs have ready received TFCSs configured according to the embodiment of FIG. 4.

As shown in FIG. 5, a Node B 10 determines if information exists for broadcast or uni-cast in step S20. Alternatively, there may be no data for broadcast or uni-cast. If the information (e.g., a data packet) is for broadcast, then in step S30, the Node B selects one of the broadcast TFCI. As explained with reference to Table 1, the block size may be X or 2X. Accordingly, if a block size of X is desired, a TFCI of 1 may be selected, and if a block size of 2X is desired, a TFCI of 2 may be selected.

If at step S20, there is no data for broadcast or uni-cast, then processing proceeds to step S60 where a TFCI of 0 is used in transmission.

If the Node B 10 wants to send a uni-cast to a particular UE. The Node B 10 must first determine the TFCI assigned to the particular UE at step S70. For example, the Node B may access a table such as Table 1 to determine the TFCI associated with the UE. Once the specific TFCI is determined, the Node B 10 sends the uni-cast to the particular UE using the obtained TFCI at step S90.

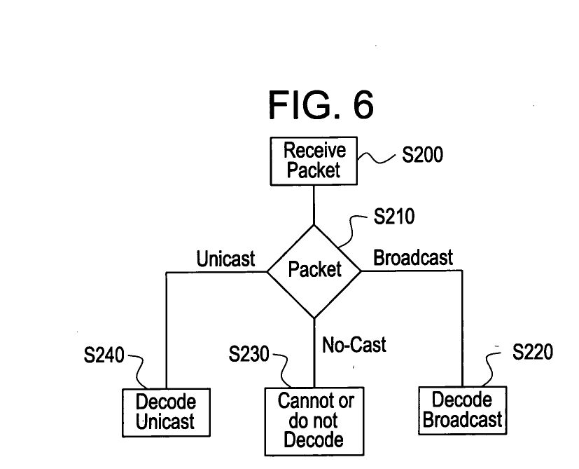

FIG. 6 is a flow chart illustrating example operation at a UE in response to broadcast or uni-cast according to the present invention. As shown, at step 200, a UE receives a packet, and at step S210 the UE determines whether the packet is broadcast, uni-cast, or no-cast. Here, “no-cast” means that the packet is destined for another UE. Therefore, the non-addressed UE cannot or does not decode the packet.

The UE makes this determination by inspecting the TFCI in the transmission. If the TFCI is one of the broadcast TFCI, then the packet is a broadcast and, at step S220, the UE decodes the packet.

If the packet is a uni-cast destined for another UE, the non-addressed UE cannot or does not decode the packet at step S230. As will be recalled, either the UE determines that there is no data to decode, or the UE determines the TFCI is invalid.

If the packet is a uni-cast meant for the UE, this is also recognized based on the TFCI in the transmission. Then at step S240, the UE decodes the packet.

As disclosed above, each of the DPCH is really bi-directional for inner-loop power control. To control the downlink (broadcast) channel power, a Node B may consider the collection of uplink power control bits from all the member UEs of the broadcast group. Although no particular Node B power control algorithm will be described, any algorithm may be used for increasing the power for as long as any UE in the broadcast group indicates it needs more power, or the algorithm may require a certain number of the UEs to indicate like power needs (increase/decrease) before the power is actually changed.

The example embodiments of the present invention being thus described, it will be obvious that the same may be varied in many ways. For example, while an example implementation of the present invention has been described with respect to an UTMS, it will be appreciated that the present invention is applicable to other telecommunication systems. Such variations are not to be regarded as a departure from the invention, and all such modifications are intended to be included within the scope of the invention.

What is claimed is:

1. A method of providing broadcast and uni-cast of information over dedicated channels, comprising:
configuring a dedicated channel for each user equipment in a broadcast group based on a first spreading code and a second spreading code, the first spreading code assigned to each user equipment in the broadcast group being a same spreading code, and the second spreading code being assigned uniquely to each user equipment in the broadcast group.

2. The method of claim 1, further comprising:
broadcasting information by sending same broadcast information over the dedicated channel for each user equipment.

3. The method of claim 2, further comprising:
uni-casting information to a selected user equipment in the broadcast group by sending uni-cast information over only the dedicated channel of the selected user equipment and sending undecodable information over the dedicated channels of unselected user equipment in the broadcast group.

4. The method of claim 2, further comprising:
uni-casting information to a selected user equipment in the broadcast group by sending uni-cast information over only the dedicated channel of the selected user equipment and sending an invalid transport format indicator over the dedicated channels of the unselected user equipment.

5. The method of claim 1, further comprising:
uni-casting information to a selected user equipment in the broadcast group by sending uni-cast information over only the dedicated channel of the selected user equipment and sending undecodable information over the dedicated channels of unselected user equipment in the broadcast group.

6. The method of claim 1, further comprising:
uni-casting information to a selected user equipment in the broadcast group by sending uni-cast information over only the dedicated channel of the selected user equipment and sending an invalid transport format indicator over the dedicated channels of the unselected user equipment.

7. The method of claim 1, wherein each dedicated channel is formed of multiple physical channels.

8. The method of claim 7, wherein each dedicated channel is a coded composite transport channel.

9. A method of providing broadcast and uni-cast of information over dedicated channels, comprising:
generating a transport format combination set for each user equipment in a broadcast group of user equipment, each transport format combination set indicating valid transport formats for the associated user equipment, and each transport format combination set configured to support selectively broadcasting and uni-casting over dedicated channels to the broadcast group of user equipment.

10. The method of claim 9, wherein the generating step comprises:
configuring a broadcast portion of each transport format combination set such that a same transport format indicator in the broadcast portion of each transport format combination set indicates a same transport format; and
configuring a uni-cast portion of each transport format combination set such that each transport format combination set is associated with one of the user equipment in the broadcast group to provide for uni-casting to the associated user equipment.

11. The method of claim 10, wherein the configuring a broadcast portion step comprises:
configuring each transport format combination set to include more than one transport format indicator indicating a transport format that provides for transmission of data.

12. The method of claim 10, wherein the configuring a broadcast portion step comprises:
configuring each transport format combination set to include at least one transport format indicator indicating a transport format that provides for no data transmission.

13. The method of claim 10, wherein the uni-cast portion of each transport format combination set is configured to include a transport format indicator for each user equipment in the broadcast group, the transport format indicator for a particular user equipment indicates a transport format providing for transmission of data if the transport format indicator is in the transport format combination set associated with the particular user equipment, and the transport format indicator for the particular user equipment indicates a transport format providing for no transmission of data if the transport format indicator is in one of the transport format combination sets not associated with the particular user equipment.

14. The method of claim 13, further comprising:
uni-casting information to a selected user equipment using the transport format indicator associated with the user equipment.

15. The method of claim 10, wherein the uni-cast portion of each transport format combination set is configured to include a transport format indicator for each user equipment in the broadcast group, the transport format indicator for a particular user equipment indicates a transport format providing for transmission of data if the transport format indicator is in the transport format combination set associated with the particular user equipment, and the transport format indicator for the particular user equipment exists only in the transport format combination set associated with the particular user equipment.

16. The method of claim 15, further comprising:
uni-casting information to a selected user equipment using the transport format indicator associated with the user equipment.

17. The method of claim 10, further comprising:
sending each transport format combination set to the associated user equipment.

18. The method of claim 10, further comprising:
broadcasting information to the broadcast group using one of the transport format indicators in the broadcast portion of the transport format combination sets.

19. The method of claim 10, wherein each dedicated channel is a coded composite transport channel.
